(19) United States
(12) Patent Application Publication
(10) Pub. No.: US 2024/0296663 A1
(43) Pub. Date: Sep. 5, 2024

(54) IMAGE PROCESSING DEVICE AND IMAGE PROCESSING METHOD

(71) Applicant: NEC Corporation, Minato-ku, Tokyo (JP)

(72) Inventors: Kenta Senzaki, Tokyo (JP); Kyoko Murozono, Tokyo (JP); Shogo Sato, Tokyo (JP)

(73) Assignee: NEC Corporation, Minato-ku, Tokyo (JP)

(21) Appl. No.: 18/273,943

(22) PCT Filed: Jan. 14, 2022
(86) PCT No.: PCT/JP2022/001112

§ 371 Date: Jul. 24, 2023

(30) Foreign Application Priority Data
Feb. 18, 2021 (JP) 2021-024043

(51) Int. Cl. G06V 10/776; G06T 7/73; G06V 10/74; G06V 10/774

(52) U.S. Cl. CPC G06V 10/776; G06T 7/74; G06V 10/761; G06V 10/774; G06T 2207/20081

(57) ABSTRACT

An estimation unit estimates attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image. An acquisition unit acquires a teacher image whose attitude similarity, which is a degree of similarity between the estimated attitude parameters and the attitude parameters related to the teacher image, is the largest among one or more teacher images included in the one or more teacher data. A first computation unit computes an image similarity, which is a degree of similarity between the target image and the acquired teacher image.

### TECHNICAL FIELD

The present invention relates to an image processing device and an image processing method, and in particular to an image processing device and an image processing method capable of detecting a decrease in estimation accuracy in object attitude estimation using machine learning.

### BACKGROUND ART

Space Situational Awareness (SSA) requires the estimation of the attitude of an object in order to understand the state of the object in space. In SSA, information such as the position, velocity, or appearance of an object is acquired by a method such as radar, optical telescopes, or satellite imaging in order to understand the state of the object in space.

One of the objectives of SSA is to estimate the 3D attitude of an object from its exterior image. In the following, it is assumed that the attitude of an object is expressed in terms of parameters such as Euler angles and quaternions.

One method for estimating the 3D attitude of an object from an image is to use image classification based on machine learning. A common image classification problem is to identify the appropriate label from predefined labels such as “dog,” “cat,” “apple,” for the object imaged in the image.

In order to apply image classification to 3D attitude estimation, each label must be corresponded to an attitude. An image classification method applied to 3D attitude estimation indirectly estimate the attitude of an object imaged in an image by identifying which of the pre-defined attitudes the attitude of an object matches.

For example, Patent Literature (PTL) 1 describes a method for suppressing the degradation of classification accuracy with respect to a specific attitude group. Specifically, PTL 1 describes a technique for suppressing the decrease in recognition accuracy regarding attitude in the vicinity of a specific attitude class when performing attitude estimation of a target object in an input image.

In addition to, as a method for estimating the 3D attitude of an object from images other than the image classification method, there is a method using regression based on machine learning, too. In the method using regression, a regression model is generated by directly learning the relationship between images and attitude parameters in a statistical manner. When an image of interest is input to a regression model that has been learned in actual operation, the regression model outputs parameters that represent the estimated attitude of the object imaged in the image of interest.

In addition, PTL 2 describes an information processing device that enables selection of an image from among a plurality of images taken of a person, such that differences in the person's attitude can be efficiently observed.

In addition, PTL 3 describes a video classification device and video classification program for classifying scenes of video, which are still or moving images, and a video retrieval device and video retrieval program for retrieving specific scenes from among video scenes.

### CITATION LIST

### Patent Literature

PTL 1: Japanese Patent No. 6188345

PTL 2: Japanese Patent Application Laid-Open No. 2018-180894

PTL 3: International Publication No. WO 2006/025272

### SUMMARY OF INVENTION

### Technical Problem

Image classification methods require databases that store labels corresponding to various attitudes, lighting environments, etc. In addition, methods that use image recognition based on machine learning, such as regression, require databases that store images for learning corresponding to various attitudes, lighting environments, etc.

However, the cost of generating in advance a data set (labels and learning images) covering all attitudes and lighting environments to be stored in the above database is high. In other words, it is difficult to generate a dataset that covers all attitudes and lighting environments.

If a dataset is used for only limited attitudes and lighting environments, the accuracy of estimating the attitude is expected to be decreased with a high probability when unanticipated situations occur during actual operations.

Even when computer graphics (CG) is used to prepare data sets for various attitudes and lighting environments, the accuracy of estimating the attitude may be decreased due to differences between CG and live-action images.

If a degradation of the accuracy of estimating the attitude is overlooked, the state of an object in space will be misjudged in SSA. If the state of the object is misjudged, important information may be missed. Missing important information may cause major problems for objects in space.

For the above reasons, it is an important issue in SSA not only to improve the accuracy of estimating the attitude but also to detect the degradation of the accuracy of estimating the attitude in actual operations. PTLs 1-3 do not describe any technology that can detect the degradation of the accuracy of estimating the attitude in actual operations.

Therefore, it is an object of the present invention to provide an image processing device and an image processing method that can detect a degradation of estimation accuracy in object attitude estimation in which machine learning is used.

### Solution to Problem

An image processing device according to the present invention is an image processing device includes an estimation unit which estimates attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image, an acquisition unit which acquires a teacher image whose attitude similarity, which is a degree of similarity between the estimated attitude parameters and the attitude parameters related to the teacher image, is the largest among one or more teacher images included in the one or more teacher data, a first computation unit which computes an image similarity, which is a degree of similarity between the target image and the acquired teacher image, and a determination unit which determines whether the computed image similarity is less than or equal to a predetermined threshold value.

An image processing method according to the present invention is an image processing method includes estimating attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image, acquiring a teacher image whose attitude similarity, which is a degree of similarity between the estimated attitude parameters and the attitude parameters related to the teacher image, is the largest among one or more teacher images included in the one or more teacher data, computing an image similarity, which is a degree of similarity between the target image and the acquired teacher image, and determining whether the computed image similarity is less than or equal to a predetermined threshold value.

A computer-readable recording medium recording an image processing program according to the present invention, when executed by a computer, stores the image processing program causing the computer to execute estimating attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image, acquiring a teacher image whose attitude similarity, which is a degree of similarity between the estimated attitude parameters and the attitude parameters related to the teacher image, is the largest among one or more teacher images included in the one or more teacher data, computing an image similarity, which is a degree of similarity between the target image and the acquired teacher image, and determining whether the computed image similarity is less than or equal to a predetermined threshold value.

### ADVANTAGEOUS EFFECTS OF INVENTION

According to the present invention, it is possible to detect a degradation of estimation accuracy in object attitude estimation in which machine learning is used.

### BRIEF DESCRIPTION OF DRAWING

FIG. 1 is a block diagram showing an example of the configuration of an image processing device of the first example embodiment of the present invention.

FIG. 2 is an explanatory diagram showing an example of an image of interest.

FIG. 3 is an explanatory diagram showing an example of the process by which the similarity computation unit 130 processes the image of interest and the teacher image, respectively.

FIG. 4 is a flowchart showing an operation of the attitude estimation accuracy determination process by the image processing device 100 of the first example embodiment.

FIG. 5 is a block diagram showing an example of the configuration of an image processing device of the second example embodiment of the present invention.

FIG. 6 is a flowchart showing an operation of the attitude estimation accuracy determination process by the image processing device 101 of the second example embodiment.

FIG. 7 is an explanatory diagram showing an example of a hardware configuration of an image processing device according to the present invention.

FIG. 8 is a block diagram showing an overview of an image processing device according to the present invention.

### DESCRIPTION OF EMBODIMENTS

### Example Embodiment 1

### [Description of Configuration]

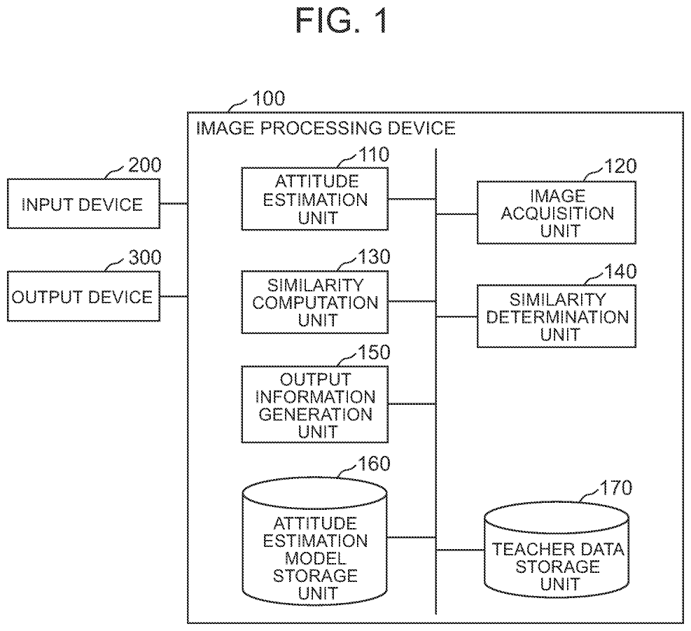

Hereinafter, a first example embodiment of the present invention will be described with reference to the drawings. FIG. 1 is a block diagram showing an example of the configuration of an image processing device of the first example embodiment of the present invention.

As shown in FIG. 1, the image processing device 100 includes an attitude estimation unit 110, an image acquisition unit 120, a similarity computation unit 130, a similarity determination unit 140, an output information generation unit 150, an attitude estimation model storage unit 160, and a teacher data storage unit 170.

As shown in FIG. 1, the image processing device 100 is communicatively

connected to an input device 200 that inputs images and related information to the image processing device 100. The input device 200 is, for example, a database in which images and related information are stored. The input device 200 may also be an interface for acquiring images and related information from the database in which the images and related information are stored.

As shown in FIG. 1, the image processing device 100 is communicatively connected to an output device 300 that outputs the processing results of the image processing device 100. The output device 300 is, for example, a visualization device for displaying the processing results, such as a display, or a printer. The output device 300 may also be a recording device that records the processing results on a storage medium such as a hard disk or memory card. The output device 300 may also be an interface that supplies the processing results to the recording device.

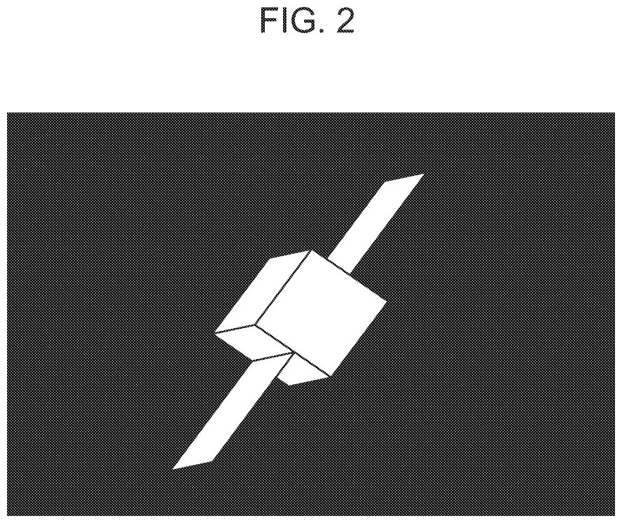

For the sake of explanation, the image that the input device 200 inputs to the image processing device 100 is referred to as the “image of interest” in this example embodiment. The image of interest is, for example, an image of a satellite taken by an optical sensor. FIG. 2 is an explanatory diagram showing an example of an image of interest.

The above “related information” is information associated with the image of interest. Related information is, for example, parameters of the shooting conditions, such as the distance between the object to be photographed and the optical sensor when the image of interest was taken, position information of the object to be photographed and the object with the optical sensor in the predetermined coordinate space, speed information, attitude information of the object with the optical sensor, position information of the light source (such as the sun). In the field of SSA, the related information is the parameters that can be acquired simultaneously with taking an image.

The following is a description of each component of the image processing device 100 according to this example embodiment.

The attitude estimation model storage unit 160 has the function of storing the structure, parameters, etc. of the image recognizer that has been previously learned with teacher data. The image recognizer uses an algorithm for estimating an attitude. In other words, the attitude estimation model storage unit 160 stores the parameters of the attitude estimation model.

The algorithm for estimating the attitude used in the above image recognizers may be an algorithm consisting of general supervised machine learning methods. In particular, the algorithm for estimating the attitude may be an algorithm consisting of a method using regression, such as Support Vector Regression (SVR) or convolutional neural networks.

The teacher data storage unit 170 has the function of storing the teacher data used in learning the parameters of the attitude estimation model stored in the attitude estimation model storage unit 160.

The teacher data used in learning is data that represents the object itself, which is the target of estimating the attitude. For example, the teacher data is a pair of 3D attitude parameters of the object that is the target of estimating the attitude and an image of the object taken. The image included in the teacher data is hereinafter referred to as the teacher image.

The teacher data storage unit 170 may store all the teacher data used for learning, or it may store a portion of the teacher data sampled as appropriate from all the teacher data.

The teacher data storage unit 170 may also store parameters of the shooting conditions, such as the distance between the object to be photographed and the optical sensor when the teacher image was taken, position information of the object to be photographed in the predetermined coordinate space, speed information of the object to be photographed, and light source position information, together. The teacher image may be a CG image generated by a 3D model as well as a taken image.

That is, the attitude estimation model in this example embodiment is a model learned using one or more teacher data, including, for example, a teacher image, which is an image of an object taken, and an attitude parameter, which is a parameter representing the attitude of an object in the teacher image.

For the sake of explanation, we will consider the case where the 3D attitude parameters are expressed in terms of Euler angles. Let θₓ, θ_{y}, and θ_{z} be the rotation parameters around the X-axis, Y-axis, and Z-axis, respectively.

The attitude estimation unit 110 has the function of estimating the attitude of an object. Specifically, the attitude estimation unit 110 acquires the structure and parameters of the attitude estimation model by referring to the attitude estimation model storage unit 160 to construct the attitude estimation model.

Next, the attitude estimation unit 110 uses the constructed attitude estimation model to estimate the 3D attitude of the object in the image of interest I_target input from the input device 200. The estimated attitude parameter θ_{target} of the object in the image of interest is defined as follows.

$${θ}^{t a r g e t} = ( {θ}_{X}^{target} , {θ}_{Y}^{target} , {θ}_{Z}^{target} ) \qquad [ Math . 1 ]$$

In other words, the attitude estimation unit 110 in this example embodiment estimates the attitude parameters of the object in the target image based on the target image (the image of interest), which is the image in which the object whose attitude is to be estimated has been taken, using an attitude estimation model. The attitude estimation unit 110 then inputs the estimated attitude parameter θ^{target} to the output information generation unit 150 and the image acquisition unit 120.

The image acquisition unit 120 receives the estimated attitude parameter θ^{target} of

the object in the image of interest I_target from the attitude estimation unit 110. The image acquisition unit 120 has the function of acquiring a teacher image from the teacher data storage unit 170 based on the input attitude parameter θ^{target}.

Specifically, the image acquisition unit 120 acquires from the teacher data storage unit 170 the image I_train, which is the teacher image of the object whose attitude is most similar to the attitude of the object in the image of interest I_target, and the related information of the image I_train.

Define the attitude parameter θ^{train,i} of the object in the i-th teacher image included in the teacher data as follows.

$${θ}^{t r a i n , i} = ( {θ}_{X}^{train , i} , {θ}_{Y}^{train , i} , {θ}_{Z}^{train , i} ) \qquad [ Math . 2 ]$$

For example, the image acquisition unit 120 computes the difference δθ¹ between the attitude parameter θ^{target} of the object in the image of interest I_target and the attitude parameter θ^{train,i} of the object in the i-th teacher image included in the teacher data as follows.

$$\begin{matrix}[ Math . 3 ] & \\ δ {θ}^{i} = {θ}^{t r a i n , i} - {θ}^{t a r g e t} & Equation ( 1 )\end{matrix}$$

The image acquisition unit 120 computes δθⁱ over one or more teacher images included in one or more teacher data, respectively. After δθⁱ has been computed over all teacher images, the teacher image with the smallest 2-norm of δθⁱ is the teacher image with the object whose attitude is most similar to the attitude of the object in the image of interest I_target.

The formula used to acquire a teacher image is not limited to Equation (1). For example, the image acquisition unit 120 may acquire the teacher image with the smallest infinity norm as the teacher image with the object with the most similar attitude.

For example, the difference between an image with an Euler angle of 0 degrees and an image with an Euler angle of 355 degrees is computed significantly, although the change in appearance is small. Therefore, the image acquisition unit 120 may add a process that limits the range of angles to [−180, 180] to the process of computing the difference. For example, the formula for computing the difference of angles around the X axis is modified as follows.

$$\begin{matrix}[ Math . 4 ] & \\ δ {θ}_{X}^{i} = ( {θ}_{X}^{train , i} - {θ}_{X}^{target} + 1 \; 80 ) \%360 - 180 & Equation ( 2 )\end{matrix}$$

The “ %” in Equation (2) indicates a remainder operation. When the difference in angles around the X axis is computed using Equation (2), the difference between 0 and 355 degrees in the Euler angle becomes −5 degrees instead of 355 degrees.

In other words, the image acquisition unit 120 in this example embodiment acquires the teacher image whose attitude similarity, which is the degree of similarity between the estimated attitude parameters and the attitude parameters related to the teacher image, is the largest among one or more teacher images included in one or more teacher data. In the above example, the inverse of the 2-norm of δθⁱ corresponds to the attitude similarity.

The image acquisition unit 120 in this example embodiment computes the attitude similarity of the teacher image over one or more teacher images included in one or more teacher data, respectively, and acquires the teacher image based on the computed attitude similarity. The image acquisition unit 120 then inputs the acquired teacher images and the related information of the teacher images to the similarity computation unit 130.

The similarity computation unit 130 has the function of computing the similarity n between the image of interest I_target and the teacher image I_train. The similarity computation unit 130 can use, for example, the peak value of the Phase Only Correlation method, the indicator of the Zero-mean Normalized Cross-Correlation, etc. as the similarity η. The similarity computation unit 130 may use indicators other than the above indicators as the similarity η.

When computing the similarity η, the similarity computation unit 130 may enlarge or reduce the image based on the distance between the object and the optical sensor, which is the related information for each I_target and I_train, so that the size of each object in I_target and I_train is approximately the same.

For example, if d_{target} is the distance between the object in I_target and the optical sensor, and dₜᵣₐᵢₙ is the distance between the object in I_train and the optical sensor, then the similarity computation unit 130 computes the following value s.

$$s = \frac{{d}_{target}}{{d}_{train}} \qquad [ Math . 5 ]$$

Next, the similarity computation unit 130 enlarges or reduces I_train by a factor of s. For example, if dₜᵣₐᵢₙ=2×d_{target}, then the similarity computation unit 130 reduces I_train so that the vertical and horizontal lengths are ½ each.

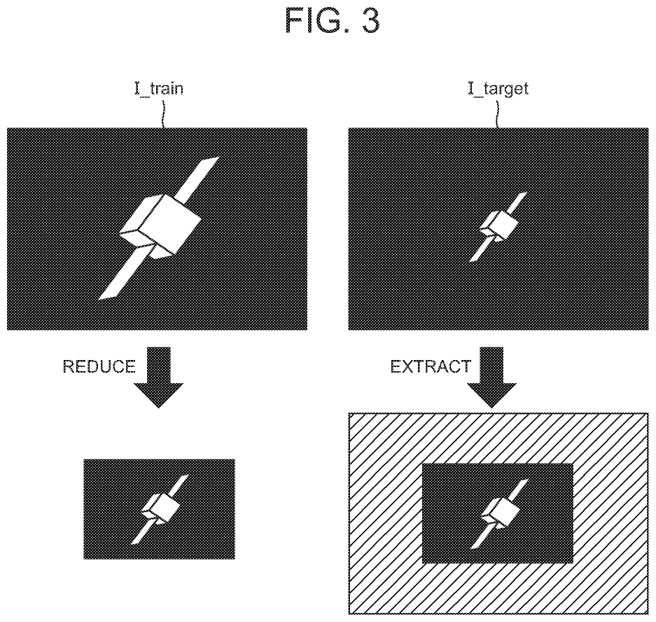

In order to make the image size of I_target equal to the image size of I_train, the similarity computation unit 130 performs the process of extracting the center to I_target. FIG. 3 is an explanatory diagram showing an example of the process by which the similarity computation unit 130 processes the image of interest and the teacher image, respectively.

In other words, the similarity computation unit 130 in this example embodiment computes the image similarity (η), which is the similarity between the target image (image of interest) and the acquired teacher image. The similarity computation unit 130 then inputs the computed similarity η to the similarity determination unit 140.

The similarity determination unit 140 has the function of comparing the similarity η input from the similarity computation unit 130 with the predetermined threshold value τ. Specifically, the similarity determination unit 140 generates flag information f indicating whether or not the similarity η is less than or equal to the predetermined threshold value τ as information representing an error in the estimated attitude, as follows.

$$f = \{ \begin{matrix}1 , & η \leq τ \\ 0 , & η > τ\end{matrix} \qquad [ Math . 6 ]$$

In other words, the similarity determination unit 140 in this example embodiment determines whether the computed image similarity is less than or equal to a predetermined threshold value. The similarity determination unit 140 then inputs the similarity η and the flag information f to the output information generation unit 150, respectively.

The output information generation unit 150 has the function of generating information to be input to the output device 300 based on the estimated attitude parameter θ^{target} input from the attitude estimation unit 110, the similarity n and flag information f input from the similarity determination unit 140.

For example, if f=1, i.e., the error of the estimated attitude parameter is estimated to be large, the output information generation unit 150 displays a message on the output device 300 warning that the error of the estimated attitude parameter is large, i.e., the accuracy of estimating the attitude may have decreased.

The output information generation unit 150 displays a warning message on the output device 300 along with the estimated attitude parameter values and similarity. Alternatively, the output information generation unit 150 may simply input a set of the estimated attitude parameter values, the similarity, and the flag information into a storage device (not shown) connected to the output device 300.

In other words, the output information generation unit 150 in this example

embodiment outputs information indicating that the accuracy of estimating the attitude has decreased when an image similarity that is below a predetermined threshold is computed.

### [Description of Operation]

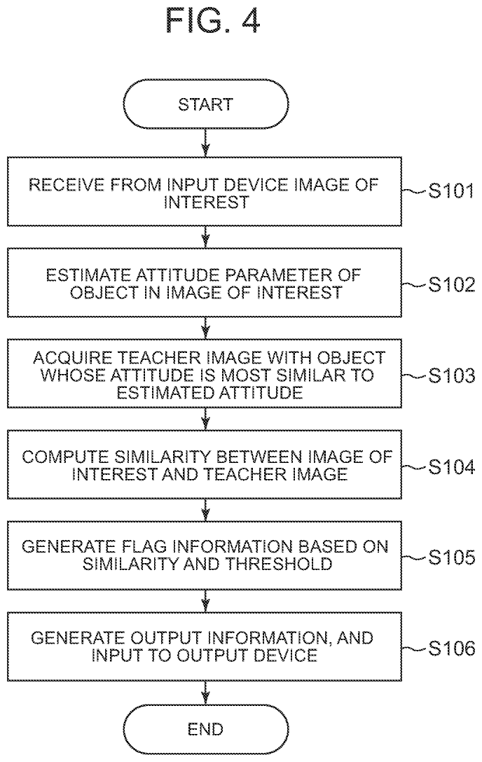

Hereinafter, the operation of the image processing device 100 of this example embodiment will be described with reference to FIG. 4. FIG. 4 is a flowchart showing an operation of the attitude estimation accuracy determination process by the image processing device 100 of the first example embodiment.

First, the image processing device 100 receives from the input device 200 an image of interest that an object to be the target of estimating the attitude has been taken and related information on the image of interest (step S101).

Next, the attitude estimation unit 110 of the image processing device 100 uses the information on the structure and parameters of the attitude estimation model stored in the attitude estimation model storage unit 160 to construct the attitude estimation model.

Next, the attitude estimation unit 110 estimates the attitude parameters of the object in the input image of interest using the constructed attitude estimation model (step S102). The attitude estimation unit 110 may have constructed the attitude estimation model in advance. The attitude estimation unit 110 inputs the estimated attitude parameters to the image acquisition unit 120.

Next, based on the estimated attitude parameters, the image acquisition unit 120 acquires from the teacher data storage unit 170 a teacher image with an object whose attitude is most similar to the attitude of the object in the image of interest (step S103). The image acquisition unit 120 inputs the acquired teacher image and the related information of the teacher image to the similarity computation unit 130.

Next, the similarity computation unit 130 computes the similarity between the image of interest and the input teacher image (step S104). The similarity computation unit 130 inputs the computed similarity to the similarity determination unit 140.

Next, the similarity determination unit 140 generates flag information indicating whether the input similarity is below a predetermined threshold (step S105). The similarity determination unit 140 inputs the similarity and flag information to the output information generation unit 150.

Next, the output information generation unit 150 generates output information based on the estimated attitude parameter values, similarity, and flag information. Next, the output information generation unit 150 inputs the generated output information to the output device 300 (step S106). After inputting the output information, the image processing device 100 terminates the attitude estimation accuracy determination process.

### [Description of Effect]

In the image processing device 100 of this example embodiment, the attitude estimation unit 110 estimates attitude parameters from an image of interest that an object to be the target of estimating the attitude has been taken. Next, the image acquisition unit 120 acquires a teacher image based on the estimated attitude parameters, and the similarity computation unit 130 computes the similarity between the image of interest and the acquired teacher image. The similarity determination unit 140 then detects a decrease in the accuracy of estimating the attitude based on the computed similarity.

In order to estimate the 3D attitude of an object in a taken image, it is effective

to utilize image recognition technology that uses machine learning. However, even when image recognition technology using machine learning is utilized, there is a problem that the accuracy of estimating the attitude decreases with a high probability when unexpected situations occur during actual operation.

Unlike, for example, the video classification device, etc., described in PTL 3, the image processing device 100 in this example embodiment acquires a teacher image with an object whose attitude is most similar to the attitude of the object in the image of interest, and judges whether the accuracy of estimating the attitude has decreased based on the similarity between the image of interest and the teacher image. In other words, the image processing device 100 can more reliably detect a decrease in the accuracy of estimating the attitude than the video classification device, etc., described in PTL 3.

By detecting a decrease in the accuracy of the attitude parameters estimated by image recognition, the user of the image processing device 100 of this example embodiment can avoid incorrectly judging the state of an object in space based on attitude parameters estimated with low accuracy.

### Example Embodiment 2

### [Description of Configuration]

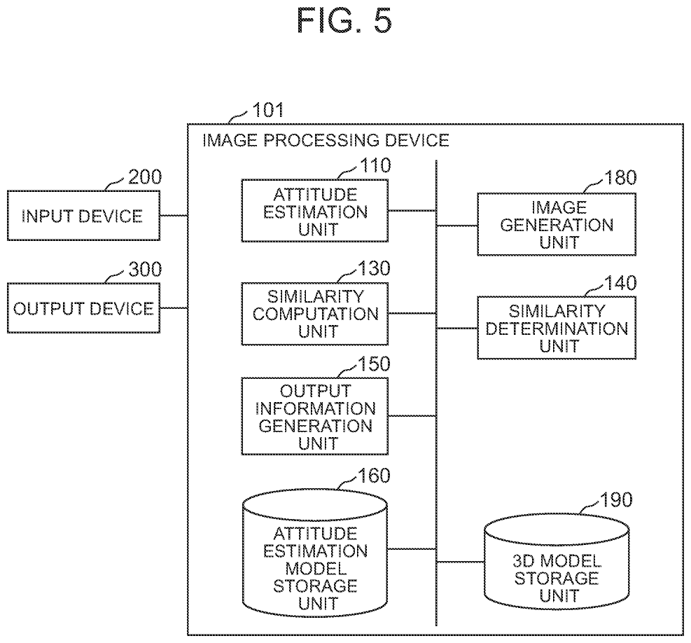

Next, a second example embodiment of the present invention will be described with reference to the drawings. FIG. 5 is a block diagram showing an example of the configuration of an image processing device of the second example embodiment of the present invention.

As shown in FIG. 5, the image processing device 101 includes an attitude estimation unit 110, a similarity computation unit 130, a similarity determination unit 140, an output information generation unit 150, an attitude estimation model storage unit 160, an image generation unit 180, and a 3D model storage unit 190. As shown in FIG. 5, the image processing device 101 is communicatively connected to the input device 200 and the output device 300, respectively.

Each function of the attitude estimation unit 110, the similarity computation unit 130, the similarity determination unit 140, the output information generation unit 150, and the attitude estimation model storage unit 160 in this example embodiment is the same as each function in the first example embodiment. Each component of the image generation unit 180 and the 3D model storage unit 190 will be described below.

The 3D model storage unit 190 has the function of storing a 3D model of the same object as the object indicated by the teacher data used in learning the parameters of the attitude estimation model stored in the attitude estimation model storage unit 160, or a 3D model of the same type of the object.

The image generation unit 180 has the function of generating a simulation image of the teacher image I_train. Specifically, the image generation unit 180 rotates the 3D model acquired from the 3D model storage unit 190 based on the attitude parameters of the object in the estimated image of interest I_target input from the attitude estimation unit 110. By rotating the 3D model, the image generation unit 180 generate a simulation image.

The image generation unit 180 may use the distance between the object in the image of interest and the optical sensor to ensure that the object in the simulation image generated from the 3D model is considered to be at the same distance from the optical sensor as the object in the image of interest. For example, the image generation unit 180 may enlarge or reduce the generated simulation image as appropriate.

In other words, the image generation unit 180 in this example embodiment generates a teacher image (simulation image) with the greatest attitude similarity based on the estimated attitude parameters. For example, the image generation unit 180 generates a teacher image using a 3D model representing an object. The similarity computation unit 130 in this example embodiment acquires the teacher image from the image generation unit 180.

### [Description of Operation]

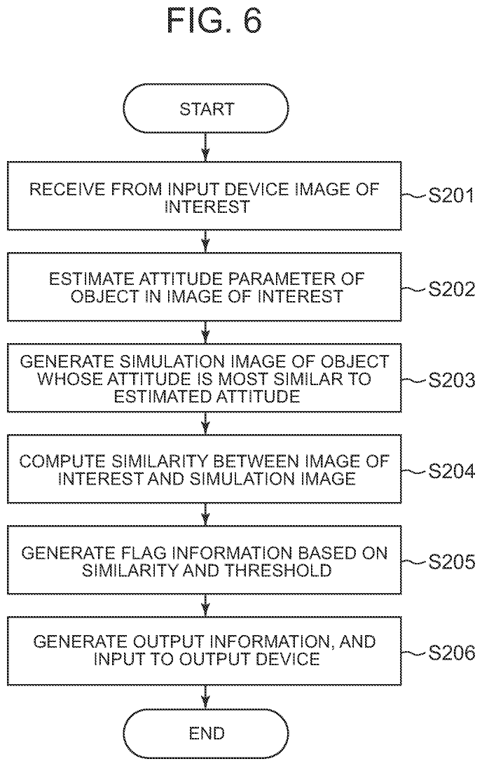

Hereinafter, the operation of the image processing device 101 of this example embodiment will be described with reference to FIG. 6. FIG. 6 is a flowchart showing an operation of the attitude estimation accuracy determination process by the image processing device 101 of the second example embodiment.

First, the image processing device 101 receives from the input device 200 an image of interest that an object to be the target of estimating the attitude has been taken and related information on the image of interest (step S201).

Next, the attitude estimation unit 110 of the image processing device 101 constructs an attitude estimation model using the information on the structure and parameters of the attitude estimation model stored in the attitude estimation model storage unit 160.

Next, the attitude estimation unit 110 estimates the attitude parameters of the object in the input image of interest using the constructed attitude estimation model (step S202). The attitude estimation unit 110 may have constructed the attitude estimation model in advance. The attitude estimation unit 110 inputs the estimated attitude parameters to the image generation unit 180.

Next, the image generation unit 180 rotates the 3D model acquired from the 3D model storage unit 190 based on the attitude parameters estimated in step S202. By rotating the 3D model, the image generation unit 180 generates a simulation image of the teacher image I_train of the object whose attitude is most similar to the attitude of the object in the image of interest (step S203). The image generation unit 180 inputs the generated simulation image and the related information of the simulation image to the similarity computation unit 130.

Next, the similarity computation unit 130 computes the similarity between the image of interest and the input simulated image (step S204). The similarity computation unit 130 inputs the computed similarity to the similarity determination unit 140.

Next, the similarity determination unit 140 generates flag information indicating whether the input similarity is below a predetermined threshold (step S205). The similarity determination unit 140 inputs the similarity and flag information to the output information generation unit 150.

Next, the output information generation unit 150 generates output information based on the estimated attitude parameter values, similarity, and flag information. Next, the output information generation unit 150 inputs the generated output information to the output device 300 (step S206). After inputting the output information, the image processing device 101 terminates the attitude estimation accuracy determination process.

### [Description of Effect]

Some or all of the teacher data used to learn the attitude estimation model is stored in the teacher data storage unit 170 of the image processing device 100 of the first example embodiment. If the sampling angle of the attitude is fine, a huge amount of data is stored in the teacher data storage unit 170, which may increase the cost of storage space.

Instead of the teacher data storage unit 170, the image processing device 101 of this example embodiment has a 3D model storage unit 190 in which a 3D model of the same object or the same type of object as the object indicated by the teacher data used in learning the parameters of the attitude estimation model is stored. In other words, the amount of data stored in the 3D model storage unit 190 does not change no matter what the value of the sampling angle of the attitude is, so the image processing device 101 can suppress the increase in the cost of storage space.

It is considered that the image processing devices 100-101 of each example embodiment are used, for example, in the field of remote sensing.

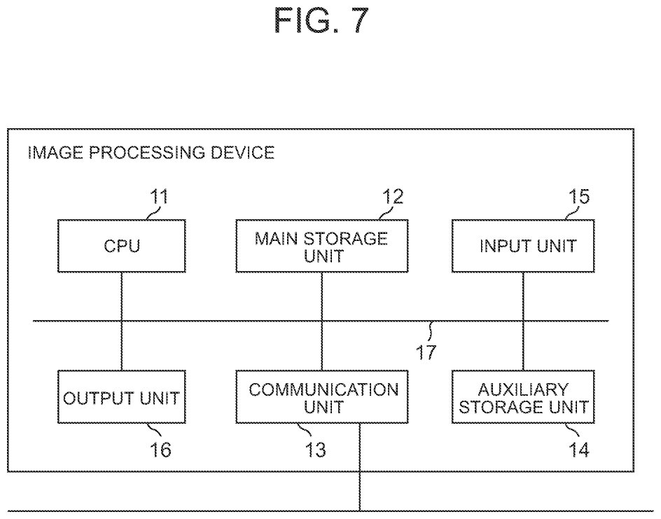

A specific example of a hardware configuration of the image processing devices 100-101 according to each example embodiment will be described below. FIG. 7 is an explanatory diagram showing an example of a hardware configuration of an image processing device according to the present invention.

The image processing device shown in FIG. 7 includes a CPU (Central Processing Unit) 11, a main storage unit 12, a communication unit 13, and an auxiliary storage unit 14. The image processing device also includes an input unit 15 for the user to operate and an output unit 16 for presenting a processing result or a progress of the processing contents to the user.

The image processing device is realized by software, with the CPU 11 shown in FIG. 7 executing a program that provides a function that each component has.

Specifically, each function is realized by software as the CPU 11 loads the program stored in the auxiliary storage unit 14 into the main storage unit 12 and executes it to control the operation of the image processing device.

The image processing device shown in FIG. 7 may include a DSP (Digital Signal Processor) instead of the CPU 11. Alternatively, the image processing device shown in FIG. 7 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function to output data. The output unit 16 is, for example, a display device such as a liquid crystal display device, or a printing device such as a printer.

As shown in FIG. 7, in the image processing device, each component is connected to the system bus 17.

The auxiliary storage unit 14 stores programs for realizing the attitude estimation unit 110, the image acquisition unit 120, the similarity computation unit 130, the similarity determination unit 140 and the output information generation unit 150 in the image processing device 100 of the first example embodiment. The attitude estimation model storage unit 160 and the teacher data storage unit 170 are realized by the main storage unit 12.

The image processing device 100 may be implemented with a circuit that contains hardware components inside such as an LSI (Large Scale Integration) that realize the functions shown in FIG. 1, for example.

The auxiliary storage unit 14 stores programs for realizing the attitude estimation unit 110, the similarity computation unit 130, the similarity determination unit 140, the output information generation unit 150 and the image generation unit 180 in the image processing device 101 of the second example embodiment. The attitude estimation model storage unit 160 and the 3D model storage unit 190 are realized by the main storage unit 12.

The image processing device 101 may be implemented with a circuit that contains hardware components inside such as an LSI that realize the functions shown in FIG. 5, for example.

The image processing devices 100-101 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

Some or all of each component of the image processing devices 100-101 may be configured by one or more information processing devices which include a computation unit and a storage unit.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

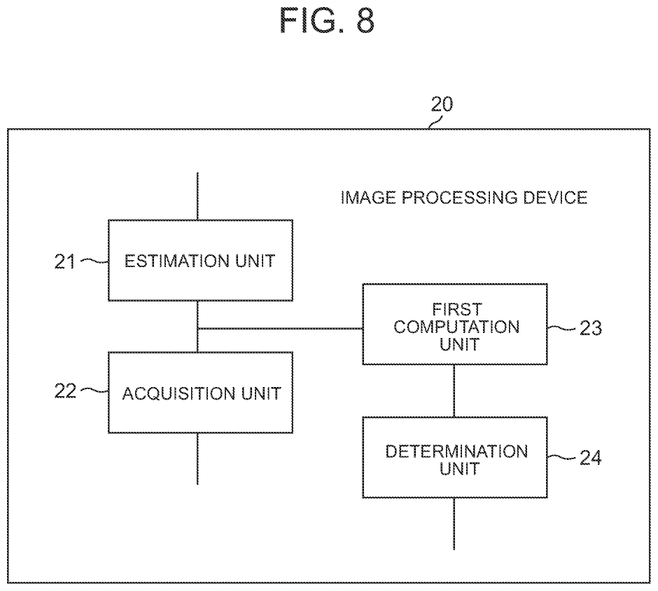

Next, an overview of the present invention will be explained. FIG. 8 is a block diagram showing an overview of an image processing device according to the present invention. The image processing device 20 according to the present invention includes an estimation unit 21 (for example, the attitude estimation unit 110) which estimates attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image, an acquisition unit 22 (for example, the image acquisition unit 120, or the similarity computation unit 130) which acquires a teacher image whose attitude similarity, which is a degree of similarity between the estimated attitude parameters and the attitude parameters related to the teacher image, is the largest among one or more teacher images included in the one or more teacher data, a first computation unit 23 (for example, the similarity computation unit 130) which computes an image similarity, which is a degree of similarity between the target image and the acquired teacher image, and a determination unit 24 (for example, the similarity determination unit 140) which determines whether the computed image similarity is less than or equal to a predetermined threshold value.

With such a configuration, the image processing device can detect a degradation of estimation accuracy in object attitude estimation in which machine learning is used.

The image processing device 20 may also include a second computation unit (for example, the image acquisition unit 120) which computes the attitude similarity of the teacher image over one or more teacher images included in one or more teacher data, respectively, and the acquisition unit 22 may also acquire the teacher image based on the computed attitude similarity.

With such a configuration, the image processing device can compute the attitude similarity by using the teacher data.

The image processing device 20 may also include a generation unit (for example, the image generation unit 180) which generates a teacher image with the largest attitude similarity based on the estimated attitude parameters, and the acquisition unit 22 may also acquire the teacher image from the generation unit. The generation unit may also generate a teacher image using a 3D model representing an object.

With such a configuration, the image processing device can suppress the increase in the cost of storage space.

The image processing device 20 may also include an output unit (for example, the output information generation unit 150) which outputs information indicating that an accuracy of estimating the attitude has decreased when an image similarity that is less than a predetermined threshold is computed.

With such a configuration, the image processing device can present a degradation of estimation accuracy in object attitude estimation to the user.

The attitude parameters may be expressed in terms of Euler angles.

With such a configuration, the image processing device can detect a degradation of estimation accuracy in estimating the attitude of rigid body.

While the present invention has been explained with reference to the example embodiments, the present invention is not limited to the aforementioned example embodiments. Various changes understandable to those skilled in the art within the scope of the present invention can be made to the structures and details of the present invention.

This application claims priority based on Japanese patent application 2021-024043 filed on Feb. 18, 2021, the entire disclosure of which is hereby incorporated herein.

### REFERENCE SIGNS LIST

11 CPU
12 Main storage unit
13 Communication unit
14 Auxiliary storage unit
15 Input unit
16 Output unit
17 System bus
20, 100, 101 Image processing device
21 Estimation unit
22 Acquisition unit
23 First computation unit
24 Determination unit
110 Attitude estimation unit
120 Image acquisition unit
130 Similarity computation unit
140 Similarity determination unit
150 Output information generation unit
160 Attitude estimation model storage unit
170 Teacher data storage unit
180 Image generation unit
190 3D model storage unit
200 Input device
300 Output device

What is claimed is:

1. An image processing device comprising:
a memory configured to store instructions; and
a processor configured to execute the instructions to:
attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image;
acquire a teacher image whose attitude similarity, which is a degree of similarity between the estimated attitude parameters and the attitude parameters related to the teacher image, is the largest among one or more teacher images included in the one or more teacher data;
compute an image similarity, which is a degree of similarity between the target image and the acquired teacher image; and
determine whether the computed image similarity is less than or equal to a predetermined threshold value.

2. The image processing device according to claim 1, wherein the processor is further configured to execute the instructions to:
compute the attitude similarity of the teacher image over one or more teacher images included in one or more teacher data, respectively; and
acquire the teacher image based on the computed attitude similarity.

3. The image processing device according to claim 1, wherein the processor is further configured to execute the instructions to:
generate a teacher image with the largest attitude similarity based on the estimated attitude parameters parameters; and
acquire the teacher image.

4. The image processing device according to claim 3, wherein the processor is further configured to execute the instructions to:
generate a teacher image using a 3D model representing an object.

5. The image processing device according to claim 1, wherein the processor is further configured to execute the instructions to:
output information indicating that an accuracy of estimating the attitude has decreased when an image similarity that is less than a predetermined threshold is computed.

6. The image processing device according to claim 1, wherein
the attitude parameters are expressed in terms of Euler angles.

7. An image processing method comprising:
estimating attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image;
acquiring a teacher image whose attitude similarity, which is a degree of similarity between the estimated attitude parameters and the attitude parameters related to the teacher image, is the largest among one or more teacher images included in the one or more teacher data;
computing an image similarity, which is a degree of similarity between the target image and the acquired teacher image; and
determining whether the computed image similarity is less than or equal to a predetermined threshold value.

8. The image processing method according to claim 7, further comprising:
computing the attitude similarity of the teacher image over one or more teacher images included in one or more teacher data, respectively; and
acquiring the teacher image based on the computed attitude similarity.

9. A computer-readable recording medium recording an image processing program causing a computer to execute:
estimating attitude parameters, which are parameters representing an attitude of an object in a target image based on the target image, which is an image in which the object whose attitude is to be estimated has been taken, using an attitude estimation model learned using one or more teacher data including a teacher image, which is an image in which the object has been taken, and the attitude parameters of the object in the teacher image;
acquiring a teacher image whose attitude similarity, which is a degree of similarity between the estimated attitude parameters and the attitude parameters related to the teacher image, is the largest among one or more teacher images included in the one or more teacher data;
computing an image similarity, which is a degree of similarity between the target image and the acquired teacher image; and
determining whether the computed image similarity is less than or equal to a predetermined threshold value.

10. The image processing program according to claim 9, causing the computer to execute:
computing the attitude similarity of the teacher image over one or more teacher images included in one or more teacher data, respectively; and
acquiring the teacher image based on the computed attitude similarity.
